(19) United States
(12) Patent Application Publication
(10) Pub. No.: US 2005/0016517 A1
(43) Pub. Date: Jan. 27, 2005

(54) Abrasive blade

(76) Inventor: Edward Robert Perry, Sedona, AZ (US)

Correspondence Address: GREENBERG TRAURIG LLP, 2450 COLORADO AVENUE, SUITE 400E, SANTA MONICA, CA, 90404, US

(21) Appl. No.: 10/859,884

(22) Filed: Jun. 2, 2004

Related U.S. Application Data
(63) Continuation-in-part of application No. 10/081,465, filed on Feb. 22, 2002.

(51) Int. Cl. B28D 1/04; C09C 1/68

(52) U.S. Cl. 125/13.01; 51/309

(57) ABSTRACT

An abrasive blade for cutting material, the blade comprising a plurality of raised portions, a plurality of recessed portions, and a plurality of transition portions. Each transition portion connects a raised portion with a recessed portion. Each of the plurality of raised portions is substantially flat; and each of the plurality of recessed portions is substantially flat and spaced laterally from the plurality of raised portions. The plurality of raised portions, the plurality of recessed portions, and the plurality of transition portions form corrugations in the abrasive blade.

### RELATED APPLICATION

The present application is the continuation-in-part of, and claims priority to, U.S. patent application Ser. No. 10/081465, filed Feb. 22, 2002, and entitled “A thin wall singulation saw blade and method”, the disclosure of which is herein incorporated in its entirety.

### FIELD OF THE DISCLOSURE

The present disclosure relates to an abrasive blade used to cut difficult to cut materials and refers particularly, though not exclusively, to a saw blade impregnated with abrasive material for use in cutting objects comprised of different materials. Saw bales according to the present disclosure have particular use as singulation saws used in the semiconductor industry. They are also of particular use in cutting large and small objects with or without coolant.

### BACKGROUND TO THE DISCLOSURE

Saw blades for cutting materials are well known. Such saw blades are made in the form of circular disc, gang saws and band saws. Circular saws may be made homogeneous comprising uniform size abrading material and a binder, or may be constructed from a support disc with abrading material bonded onto the outer periphery. The outer periphery may be continuous or discontinuous. One of the purposes of providing a discontinuous pattern is that the grooves or passageways between the attached abrading material provides a resistance free passage for the outflow of abraded particles cut from the material and/or an associated coolant used to cool the saw blade as well as flush particles out of the blade.

Dicing saws are employed in the semiconductor industry to separate individual dies from each other by cutting streets or separation channels into the hard, brittle wafer comprising a plurality of dies. The smaller the die, and the more narrow the street, the greater the yields of sawn dies from a given size wafer. Further, the more narrow the streets, the greater number of dies that can be made onto a wafer of a given size. For this and other reasons, wafer dicing saw blades are made very thin. Typical electrodeposited binder material diamond impregnated saw blades have been made with a thickness over a large range such as, for example, from less than one thousandth of an inch up to several thousandths of an inch.

Saw blades of the solid type have a tendency to form a bullet shape after some use. This causes them to be rejected by the singulation industry because as the sides of the blades wear the bottom of the blade becomes smaller and the package being cut grows directly with this wear. In consequence the package becomes wider and out of its specification. This means the blade must be replaced before the blade is completely worn.

Some substrates have been singulated using thick dicing saw blades in dicing type saws but the blades are destroyed by the binder material layers in the substrate. Such thick blades require many hours to make, require coolant, yet rapidly clog with plastic and binder material from the circuits causing burrs and or torn circuits. The clogged blade then requires a greater force to make a cut, and cuts at a much slower rate because the diamonds that do the cutting are less exposed leaving no room for the newly cut debris. The newly cut debris abrades the blade matrix material causing excessive wear.

Some substrates have been singulated using solid resinoid saw blades and/or sintered saw blades. When clogged, these blades have a tendency to make rough cuts which can smear or destroy the exposed circuit pattern, especially when the smear occurs at a conductive pad or bump on the die. This causes electrical leakage between them or, in some cases, ripping them out altogether. Also, such blades form a bullet shape after use causing burrs thus making the packages out of specification. Therefore, the blades must be replaced relatively early in their use cycle.

### SUMMARY OF THE DISCLOSURE

According to a first aspect there is provided an abrasive blade for cutting material, the blade comprising: a plurality of raised portions; a plurality of recessed portions; and a plurality of transition portions. Each transition portion connects a raised portion with a recessed portion. Each of the plurality of raised portions is substantially flat, and each of the plurality of recessed portions is substantially flat and spaced laterally from the plurality of raised portions. The plurality of raised portions, the plurality of recessed portions, and the plurality of transition portions form corrugations in the abrasive blade.

The raised portion and the recessed portion may be parallel to each other. Each transition portion may be angled relative to the raised portion and the recessed portion by an angle in the range 30 to 90 degrees, preferably 45 degrees. Each of the recessed portions may be spaced longitudinally of the raised portions. The raised portion and the recessed portion may each have a front edge that forms a corrugated edge at the junction with the transition portion. Each raised portion and each recessed portion may have a top portion surface and a bottom portion surface, a distance between the top portion surface of a raised portion and the bottom portion surface of a recessed portion defining a curf width of the blade, a distance between the top portion surface and the bottom portion surface defining a portion depth of the blade, a ratio between the portion depth and the curf width of the blade defining a corrugation depth of the blade, the corrugation depth being less than 1.

The blade may comprise a mixture of a binder material and particles of abrasive material encapsulated in the binder material. The particles may comprise large particles having a dimension no greater than 50% of the depth portion, and small particles having a dimension in a range of 10% to 30% of the dimension of the large particles. The blade may have a top blade surface and a bottom blade surface, a distance between the top blade surface and the bottom blade surface defining a blade depth. The particles of abrasive material may have a dimension in a range of 10% to 50% the blade depth. The large particles of abrasive material may be in an amount of about 10% to about 60%, preferably from about 30% to about 40% by volume of the abrasive blade.

In a second aspect there is provided an abrasive blade for cutting material, the abrasive blade comprising a plurality of raised portions, recessed portions and transition portions, each transition portion connecting a raised portion with a recessed portion. Each portion may have a top portion surface and a bottom portion surface. A distance between the top portion surface of a raised portion and the bottom portion surface of a recessed portion defines a curf width of the blade. A distance between the top portion surface and the bottom portion surface defines a portion depth of the blade. A ratio between the portion depth and the curf width of the blade defines a corrugation depth of the blade, the corrugation depth being less than 1.

Each transition portion may have an inclination relative to the raised portion and recessed portion connected by said each transition portion, the inclination being less than 90 degrees, preferably 45°±15°. The corrugation depth may be substantially uniform along the blade. The blade may have a contacting surface adapted to contact the material during cutting, and comprises a mixture of binder material and particles of abrasive material encapsulated in the binder material, the particles forming at least a portion of the contacting surface of the blade. The particles may comprise large particles having a dimension ≦50% of the depth portion, and small particles having a dimension in a range of 10% to 30% of the dimension of the large particles.

According to a third aspect there is provided an abrasive blade for cutting materials, the blade made of a mixture of binder material, large particles of abrasive material and small particles of abrasive material. The large and small particles of abrasive material are encapsulated in the blade. The blade has a contacting surface adapted to contact material during cutting such that the small particles of abrasive material at least in part protect the binder material during cutting.

The blade may have a top blade surface and a bottom blade surface, a distance between the top blade surface and the bottom blade surface defining a blade depth, and the large particles of abrasive material may each have a dimension in a range of 10% to 50% the blade depth. The large particles of abrasive material may be in an amount of about 30% to about 40% by volume of the abrasive blade. The blade may be a corrugated blade having an upper surface and a lower surface, including raised portions, recessed portions and transition portions, the transition portions connecting the raised portions and the recessed portions. Each portion may have a top portion surface and a bottom portion surface, the large and small particles of abrasive material encapsulated in the binder material being distributed between the top portion surface and the bottom portion surface.

A distance between the top portion surface and the bottom portion surface may define a portion depth of the blade, the portion depth preferably being about 10% to 60% of a distance between the top portion surface of a raised portion and the bottom portion surface of a recessed portion of the blade.

According to a fourth aspect there is provided an abrasive blade for cutting materials, the blade having an upper surface, a lower surface, and a blade depth defined by a distance between the upper surface and the lower surface. The blade comprises a mixture of binder material and particles of abrasive material. The particles comprise large particles and small particles. The large particles have a large particle dimension up to about 50% the blade depth. The small particles have a small particle dimension from about 10% to about 30% of the large particle dimension.

The blade may have a contacting surface adapted to contact the materials during cutting and a portion of the contacting surface may be formed by the particles of abrasive material. The large particles may be encapsulated in the binder material and may be in an amount of about 30% to about 40% by volume of the abrasive blade. The small particles may be encapsulated in the binder material and may be in an amount of about 10% to about 20% by volume of the abrasive blade. The blade may be a singulation saw blade; the binder material may be a metal and the abrasive material may be diamond. The blade may have a shape selected from the group consisting of a disc shape, a pipe shape, and a ribbon shape.

According to a fifth aspect there is provided an abrasive blade for cutting material, the blade comprising a plurality of raised portions, recessed portions and transition portions. Each transition portion connects a raised portion with a recessed portion. Each portion has a top portion surface and a bottom portion surface. A distance between the top portion surface of a raised portion and the bottom portion surface of a recessed portion defines a curf width of the blade. A distance between the top portion surface and the bottom portion surface defines a portion depth of the blade. A ratio between the portion depth and the curf width of the blade defines a corrugation depth of the blade, the corrugation depth being less than 1. The abrasive blade is of a mixture of binder material and particles of abrasive material encapsulated in the binder material. The particles of abrasive material include large particles having a diameter ≦50% the depth of the blade and small particles having a diameter in a range from 10% to 30% of the diameter of the large particles.

The blade may have a contacting surface adapted to contact the material during cutting, wherein a portion of the contacting surface is formed by the large particles of abrasive material. The transition portions may have an inclination angle in a range of 30° to 60° with respect to the raised portions and recessed portions. The blade may be a singulation saw blade and may have a shape selected from the group consisting of a disc shape, a pipe shape, and a ribbon shape.

According to a sixth aspect there is provided a method for manufacturing an abrasive blade having a blade depth, the method comprising:
mixing together a binder material and abrasive particles, the abrasive particles comprising large abrasive particles and small abrasive particles, the large abrasive particles having a dimension of ≦50% of the blade depth, the small particles having a dimension in a range of 10% to 30% the dimension of the large particles; and
plating the mixed binder material and abrasive particles.

Plating may be performed on a mandrel. The plated mixed binder material and abrasive material may be subsequently removed from the mandrel.

According to a seventh aspect there is provided a method for manufacturing an abrasive blade comprising:
plating first abrasive material particles in a binder material plating bath;
adding second abrasive material particles having a dimension greater than the first abrasive material particles to the binder material plating bath;
adding further first abrasive particles; and
performing further plating up to a desired thickness, thus forming a blade where the first abrasive material particles and the second abrasive material particles are encapsulated in the binder material.

The binder material plating bath may be a nickel plating bath.

According to an eighth aspect there is provided a method for manufacturing an abrasive blade, the method comprising:
providing a mandrel;
performing a binder material plating in a plating bath;
adding large abrasive material particles and small abrasive material particles up to a thickness less than a desired final thickness;
plating the binder material to the desired final thickness without adding large abrasive material particles and small abrasive material thus forming a blade where the large and small particles of abrasive material are encapsulated in the binder material; and
removing the formed blade.

The mandrel may have a corrugated pattern.

According to a ninth aspect there is provided a method for manufacturing an abrasive blade, the method comprising:
providing a support;
performing a first binder material bath plating where large abrasive material particles are plated on to the support;
stopping the first bath plating at a first predetermined depth; and
performing a second binder material bath plating where small abrasive material particles are plated to a depth less than the depth of the large particles.

The support may be a mandrel having a corrugated pattern.

According to a final aspect there is provided a thin wall singulation blade for cutting materials, comprising: a plated binder material matrix for encapsulating large abrasive material and small abrasive material in the binder material matrix, the binder material matrix comprising small abrasive material particles substantially surrounding large abrasive material particles in the binder material matrix; the thin wall singulation blade being corrugated in shape and having a plurality of substantially flat raised portions, and a plurality of substantially flat recessed portions, the raised portions and recessed portions being separated and joined by transition portions.

The thin wall singulation blade may have a depth of corrugation in the range 2 to 10 times the thickness of the thin walls of the thin wall singulation blade. The matrix material in the thin walls may have a cutting area that exceeds the cutting area of the transition portions so that the sidewalls wear slower than the area between the sidewalls. The saw blade may have a cutting edge that becomes concave and the center of the blade becomes recessed between two parallel cutting sidewall blades.

### BRIEF DESCRIPTION OF THE OF DRAWINGS

FIG. 1 is a partial cross-sectional view of a corrugated blade according to a first embodiment;

FIG. 1a is a partial cross sectional view of a corrugated blade according to a second embodiment;

FIG. 2 is a partial perspective view of the corrugated blade of FIG. 1;

FIG. 3 is an enlarged view of the blade of FIG. 1 according to a third embodiment;

FIG. 4 is an enlarged view of the blade of FIG. 1 according to a fourth embodiment;

FIG. 5 is an enlarged view of the blade of FIG. 1 according to a fifth embodiment;

FIG. 6 is an enlarged view of the blade of FIG. 1 according to a sixth embodiment;

FIGS. 7A-7E are views relating to a detail of a non-corrugated blade;

FIGS. 8A-8E are views relating to details of three different section of a corrugated blade;

FIG. 9 is a cross-sectional view corresponding to an enlarged view of FIG. 7E;

FIG. 10 is a cross-sectional view corresponding to an enlarged view of FIG. 8E;

FIG. 11 is a perspective view from the top of a annular corrugated disc blade according to the disclosure;

FIG. 12 is a perspective view from the top of a pipe blade according to the disclosure;

FIG. 13 is a perspective view from the top of a ribbon or band blade according to the disclosure;

FIG. 14 is a perspective view from the top of an annular disc blade according to the disclosure, placed in a hub.

FIG. 15 is an exploded side perspective view of the annular disc blade and hub of FIG. 14;

FIG. 16 is a plan view from the top of an annular disc blade according to the disclosure, attached to a disc support;

FIG. 17 is a cross-sectional view of the annular disc blade and support of FIG. 16;

FIG. 18 is a perspective view from the top of a drill pipe according to the disclosure, with a pipe support;

FIG. 19 is a partial top and side perspective view of a band blade or ribbon according to the disclosure, having a band or ribbon support;

FIG. 20 is a perspective view of an electroforming mandrel and an annular disc blade according to the disclosure;

FIG. 21 is a block diagram of a first embodiment of a method to make a blade according to the disclosure;

FIG. 22 is a block diagram of a second embodiment of a method to make a blade according to the disclosure;

FIG. 23 is a block diagram of a third embodiment of a method to make a blade according to the disclosure; and

FIG. 24 is a block diagram of a fourth embodiment of a method to make a blade according to the disclosure.

### DETAILED DESCRIPTION OF PREFERRED EMBODIMENTS

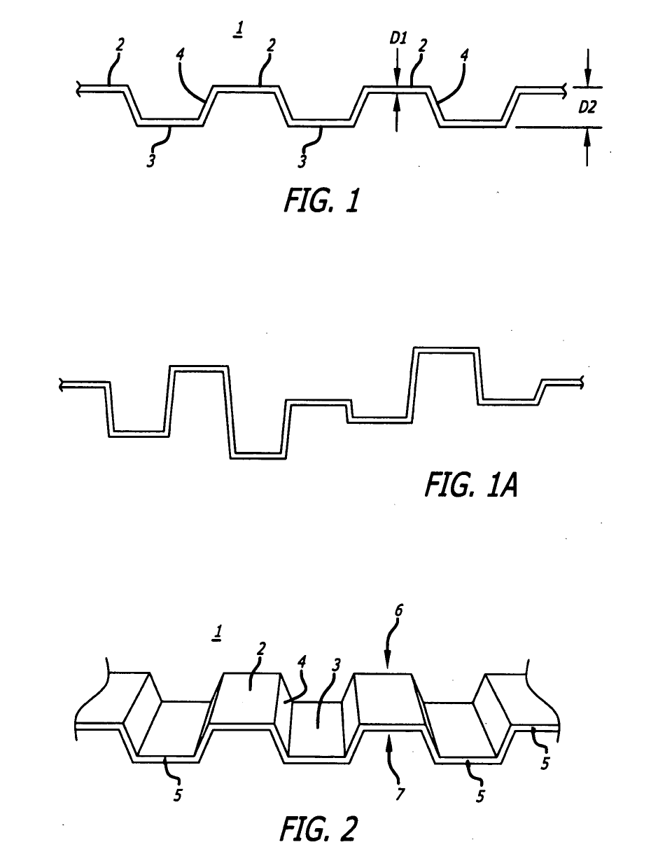

FIG. 1 shows a cross-sectional view of a blade (1). The blade (1) has a corrugated shape and comprises alternating raised portions (2) and recessed portions (3). Transition portions (4) of the blade (1) join and separate the raised portions (2) from the recessed portions (3) such that the raised portions (2) and the recessed portions (3) are spaced apart laterally and longitudinally. The raised portions (2) and the recessed portions (3) are preferably substantially flat and are each in planes that are substantially parallel. By adopting a corrugated shape, a relatively thin material may be used without reducing the inherent strength of the blade (1). Also, the corrugated shape assists in removal of waste material, and also assists in the blade (1) generating an airflow. The generated airflow further assists removal of waste material, and cooling of the blade (1).

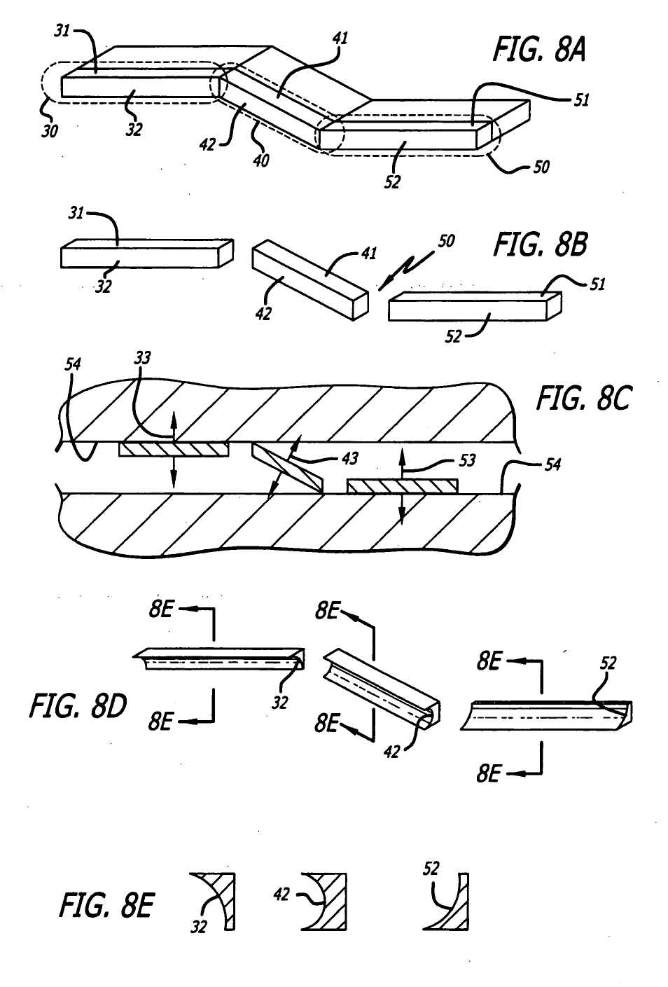

Transition portions (4) abrade the material between the raised portions (2) and recessed portions (3). The presence of transition portions (4) connecting raised portions (2) and recessed portions (3) allows the portions of the blade to assume an at least partial concave shape, instead of the bullet shape of the prior art, when the blade is in use (see below FIG. 8).

In the blade (1) each transition portion has an inclination relative to the raised portion and recessed portion of 45 degrees. The inclination of the transition portion (4) can vary depending on the intended use of the blade (1) and on the material to be cut. The inclination can be of less than 90 degrees, less than 60° and more preferably in the range of 30 degrees to 60 degrees depending on the desired use of the blade. For example, in the singulation industry, the preferred inclination of the transition portion is 45±15 degrees, more preferably 45 degrees.

Inclination of the transition portion (4) is also important to make the blade (1) flexible and self-aligning when clamped in a hub or fixture. Inclination of the transition portions (4) can vary inside

By varying the number of raised portions (2) and recessed portions or grooves (3) other properties of the blade, such as flexibility, may be varied.

FIG. 1 also shows the portion thickness or portion depth (D1) of a raised portion (2). Usually, the raised portions (2), recessed portions (3) and transition portions (4) have substantially the same portion depth D1. The curf width of the blade, i.e. the distance between the top surface of the raised portions (2) and the bottom surface of the recessed portions (3) is indicated with (D2). The curf width of the blade gives the total cutting thickness of the blade.

For example, in singulation industry the thickness (D1) is preferably about 2 to 7 mils. The thickness of the portions (2), (3) and (4) is usually about 10% to 60% of the thickness (D2). For example, when the portions (2), (3), and (4) are about two mils thick each, the blade (1) can have a depth D1 of about 8 mils and results in a curf width of 10 mils. Also blades approximately 2 mils thick have been made, having a corrugated surface comprising about 120 grooves. Those blades provide a clean cutting blade and are rigid and self-flattening when clamped. The portion depth D1 is preferably substantially uniform along the blade.

For a corrugated blade the depth of the corrugation D3, is a function of the portion depth D1 and the curf width D2 of that blade. D3 is defined by D1/D2 and is preferably always less than 1.

The depth of the corrugation D3, the portion depth D1 and the curf width D2, as well as the length and number of raised and recessed portions, vary depending on the configuration and the intended use of the blade. In particular, determination of the above parameters is functional to the material to be cut, blade strength, operating speed and the desired depth of the cut to be performed.

The desired corrugation depth depends also on parameters such as the diameter of the disc, in case of disc blades, or diameter of the support in case of blades mounted on a pipe. For example, the corrugation depth is deeper when blades are made for very large discs and band saw blades.

The above parameters may also be varied along a single blade in consequence of the intended use of the blade (1).

For example, the depth of the corrugation D3 can vary along the blade (1) to force the center cutting of the blade. FIG. 1A shows a cross-sectional view of a blade (100) wherein D1, D2 and D3, as well as the length of the raised portions (2) the recessed portions (3) and the transition portions (4), is varied along the blade. In particular, the depth of the corrugation D3 of the blade (100) is varied to force center cutting without loosing the outer edge quality of the cut.

Accordingly, the variation in the D3 value along the corrugated blade (1) results in a blade able to provide a cut with fair squared edge. This kind of cut is of the kind obtainable with a standard carbide saw blade and is hereby obtained with a blade that, contrary to the carbide saw blade, does not develop the bullet shape. This embodiment is preferred for blade having a relatively wide curf width, such as the saw blades employed in, for example, the lodging industry.

The embodiment shown in FIG. 1A above is only one example of all possible combinations of the above parameters. Other combinations functional to various uses of the blade are identifiable by a person skilled in the art upon reading of the present disclosure.

FIG. 2 shows a perspective view of the blade shown in FIG. 1. The blade width and the linear extension of the blade (1) are shown for exemplary purposes only. For example, the width of the blade (1) can be larger or smaller than the width of the Figure, and the extension of the blade (1) can be circular. The front side of the raised portions (2), recessed portions (3), and transition portions (4) form a corrugated edge (5).

It should be appreciated that the external periphery of the blade shown in FIG. 2 is comprised of three main regions: a top surface (6), a bottom surface (7), and the corrugated edge (5), thus defining a top periphery, a bottom periphery, and an edge periphery of the blade (1).

According to the present disclosure, the blade is made of a combination of a binder material and a abrasive material. The binder material may be of any suitable nature such as, for example, a binder material, a plastics material, an epoxy material, fiberglass, and so forth. The nature of the binder used will depend solely on the material being abraded. For example, it may be a relatively soft material if abrading a soft material. If the material being abraded is quite hard, the binder will need to be relatively hard. It is preferred that the binder material be at least of the same order of hardness as the material being abraded. If the binder is a metal it may be, for example, nickel. Also, the nature of the abrasive material will depend on the intended use of the blade (1). If the blade is being used for singulation or for cutting of concrete, mineral material, metal, house walls, and so forth, the abrasive material may be, for example, diamond. However, if the blade (1) is being used in the logging industry it may be a different material such as, for example, garnet, granite or marble. In particular, the combination comprises large particles of the abrasive material mixed with, encapsulated in, or embedded in the binder material.

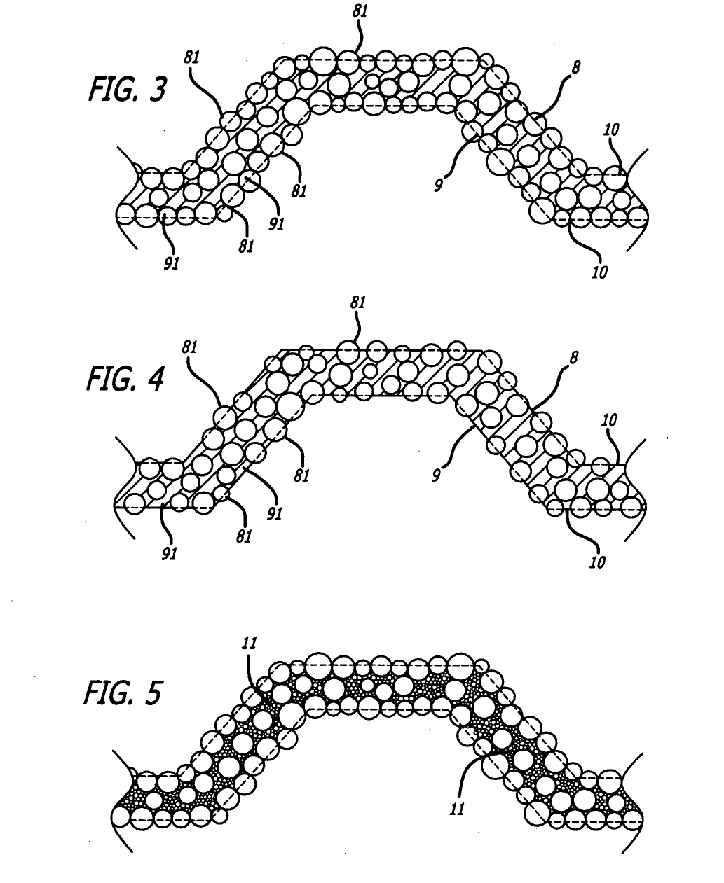

FIG. 3 shows an enlarged view of a portion of FIG. 1, where the materials forming the blade are shown in greater detail. In particular, large particles (8) of a abrasive material, such as diamond, are mixed with a binder material (9) such as nickel, forming a matrix having a corrugated shape. With regard to the binder material materials, binder materials such as nickel, tungsten, nickel cobalt, and various alloys may be used. In the logging industry, corrosion resistant metals and alloys of metals, such a nickel chrome alloy, would be the preferred binder material because of the acid nature of tree sap.

The large particles (8) embedded in a blade (1) need not to be of the same abrasive material, for example in the singulation industry a mixture of fine diamonds and cubic boron nitride is suitable for some applications. The large particles preferably have a dimension that is ≦50% of D1, preferably from 10% to 50% of the portion depth D1. More preferably the dimension of the particles is from 12% to 20% of D1, which in a blade having a curf width D2 of 7,000 to 20,000 micron and a portion depth D1 that corresponds to a dimension of 20 to 25 micron diameter for each large particle.

The dimensions of the large particles (8) vary depending on the intended use of the blade. Singulation blades, for example, may have particle sizes in the 3 to 50 micron range while in large discs or band saw blades, the abrasive particles may have a diameter of up to 500 microns or more. The particles included in a blade need not have the same dimensions. The size of the particles and of the blade depends also on the desired results, wherein smaller size of the blade and particles is associated with a more polished finish of the cut, while larger size of the particles and blade are associated with a coarse cut.

The amount of particles included in the binder material also varies depending on the intended use of the blade. For singulation blades, the amount of the abrasive particles included is about 5% to 75% of the total volume of the corrugated blade.

According to the embodiment shown in FIG. 3, the blade has a peripheral shape not necessarily defined by the binder material (9) only. In other words, some particles (81) of the large particles (8) could well be on the top, bottom, or edge periphery of the blade (1) together with portions (91) of the binder material (9). FIG. 3 also shows peripheral broken lines (10) to underline the overall shape of the blade. The person skilled in the art will understand, however, that the broken lines (10) are not part of the blade (1) and are present for clarity purposes only.

Therefore, according to the embodiment of FIG. 3, each of the top periphery, bottom periphery, and edge periphery of the blade (1) is defined by a combination between the large particles (81) and the binder material (91), wherein the proportion between the large particles (81) and the binder material (91) forming the external periphery of the blade (1) is greatly in favor of the large particles (81). A particular case of this embodiment is a case where the external periphery of the blade (1) is formed by the large particles (81) only that, in this case, “protrude” from the peripheral broken line (10) underlining the shape of the blade.

FIG. 4 shows an enlarged view of a portion of FIG. 1 in accordance with a further embodiment. In the embodiment of FIG. 4, differently from the embodiment of FIG. 3, although the external periphery of the blade (1) is still formed by a combination between the large particles (81) and the binder material (91), the proportion between the large particles (81) and the binder material (91) forming the external periphery of the blade (1) is greatly in favor of the binder material (91), with large particles (81) still forming at least a portion of the periphery of the blade. (1).

With reference to the embodiments of FIGS. 3 and 4, the person skilled in the art will understand that “intermediate” embodiments are also possible, where, for example, the top periphery is formed according to the embodiment of FIG. 3, and the bottom and edge peripheries are formed according to the embodiment of FIG. 4.

During operation of the blade (1), cutting of the materials mainly occurs because of the abrasive particles located along the edge (5) of FIG. 2. Once the outermost abrasive particles located along the edge (5) are swept away due to the contact with the material to be cut, those particles are replaced by the other abrasive particles located into the blade in accordance with the embodiments shown in FIGS. 3 and 4. In particular, the structure shown in FIGS. 3 and 4 always allows for the formation of a new edge periphery structured in the same way as the edge periphery that has just been swept away due to the cutting operation.

When the blade is in use, the abrasive particles are removed from the binder material in an approximately uniform way. This is also functional to the formation of a concave shape in the edges of the blade in embodiments wherein the blade is corrugated (see below FIG. 8).

The person skilled in the art will also understand that the greater the connection of a particle of abrasive material with the binder material, the more difficult for that particle to be swept away. Therefore, there is a slight difference in performance between the embodiment of FIG. 3 and the embodiment of FIG. 4, in the sense that the embodiment of FIG. 3 allows for a better longevity of the blade, because it is more difficult for the outermost particles (81) to be swept away than the outermost particles (81) of the embodiment of FIG. 4. Therefore, the amount of abrasive particles (81) exposed to the wear action is greater in the embodiments of FIG. 3 than the amount of binder material (91) compared to the amount of particles and binder material in the embodiment of FIG. 4.

According to one embodiment of the present disclosure, small particles of abrasive material can be added to the combination between the binder material and large particles of abrasive material described above. Preferably, the small and large abrasive material particles are made of the same abrasive material. Alternatively, they may be different. However, if different, they are preferably of the same order of hardness. The presence of the small particles of abrasive material further slows the wear of the large particles from the blade by obstructing removal of the binder material by the abrasive action of the cut material. The presence of the small particles of material may also cause a more polished finish to the cut.

FIG. 5 shows an embodiment similar to the embodiment of FIG. 3, where small particles (11) of abrasive material are also present.

The small particles have a dimensions ranging from 10% to 30% of the large particles. In a singulation blade for example, the large particles have a dimension from 20 to 25 microns. Therefore, the small particles (11) would have a dimension in the range of 1 to 5 microns.

The dimensions of the small particles (11) and of the large particles (81), as well as the relative amounts to be encapsulated in the matrix (91), vary depending on the intended use of the blade.

The amount of particles included in the binder material (1) also depends on the intended use of the blade. For example, in saw blades to be used as singulation blades, small abrasive particles may be 10% to 20% by volume of the blade (1); large abrasive particles may be about 30% to 40% by volume of the blade (1); and the rest of the matrix is made of binder material.

According to the embodiment of FIG. 5, each of the top periphery, bottom periphery, and edge periphery of the blade (1) is defined by a combination between the large particles (81), the binder material (91), and the small particles (11), wherein the proportion between the large particles (81), the binder material (91), and the small particles (11) forming the external periphery of the blade (1) is greatly in favor of the large particles (81). A particular case of this embodiment is a case where the external periphery of the blade (1) is formed by the large particles (81) only.

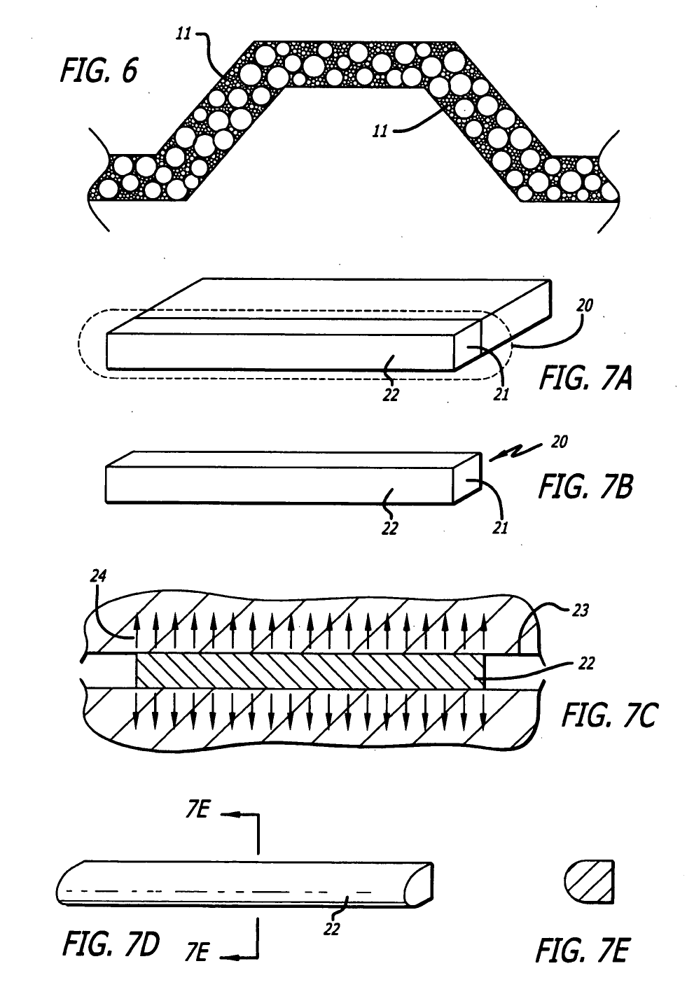

FIG. 6 shows an embodiment formed by a combination of binder material (91), and large particles (81) and small particles (11) of abrasive material. In contrast to the embodiment of FIG. 5, in the embodiment of FIG. 6 the proportion between the large particles (81), the binder material (91), and the small particles (11) forming the external periphery of the blade (1) is greatly in favor of the binder material (91) and small particles (11). However, the external periphery of the blade (1) is still formed by a combination between the large particles (81), the binder material (91), and the small particles (11). A particularly preferred case of this embodiment is a case where the external periphery of the blade (1) is formed by the binder material (91), or by binder material (91) and small particles (11) only.

This last embodiment wherein the external periphery is formed by small particles (11) and binder material (91) only, the proportion in favor of the small particles (11) is desirable for blades used to obtain a more polished finish.

The person skilled in the art will understand, upon reading of the present disclosure, that the presence of the small abrasive particles assists in binding the large abrasive particles in the binder material by protecting the binder material from abrasion during operation of the blade (1). Although the small abrasive particles do not significantly improve the cutting function of the blade, they do form an additional abrasive surface. Also, when included in the blade small surface that is the last surface abraded thereby providing an improved finish to the cut.

Therefore, when the small abrasive particles are included, the presence of the abrasive material in the blade has the advantageous dual function of cutting (large particles) and reducing abrasive wear of the blade (1). In these preferred embodiments, the abrasive material particles are held by an optimum or maximum holding force. This permits the blade (1) to have a clean cut without clogging. In the singulation industry cutting speeds of up to 450 mm per second have been achieved.

FIGS. 1-6 show embodiments of the present disclosure where the blade is corrugated. However, the present disclosure is also suitable with non-corrugated blades. Usually, a corrugated blade is to be preferred over a non-corrugated blade because the cross-section of the edge of the blade becomes concave after repeated operation of the blade, and not convex as in a non-corrugated blade. The concave shape of the edge of the blade is particularly preferred in singulation blades. The amount of matrix material in the center of each portion is a less than that at the outer edges thus the center of each portion wears faster than the outer edges, thus giving a concave shape. The concave shape is a preferred shape for singulation saw blades. The outer edges tend to wear uniformly flat so that minimum chipping occurs when they break through the bottom surface of an article being cut.

The above concept is better explained with reference to FIGS. 7A-7E (non-corrugated blade) and FIGS. 8A-8E (corrugated blade).

FIG. 7A shows a portion (20) of a non-corrugated blade having an edge region (21) with a front side or periphery (22). FIG. 7B shows the edge region (21) before cutting. The front side (22) of the edge region (21) is flat. In FIG. 7C the movement of the debris particles with respect to the front side (22) of the edge region (21) when the non-corrugated blade cut a material (23) is shown by arrows (24). FIG. 7D shows an enlargement of the edge region (21) after repeated cutting operations. The front side (22) is now convex, as better shown in the cross sectional view of view of FIG. 7E. This is particularly disadvantageous in prior art embodiments, where the abrasive material is present only on the peripheral region of the binder material matrix. More specifically, convexity of the front side of the edge region reduces the amount of abrasive material on the blade.

FIG. 8A shows portions (30), (40), and (50) of a corrugated blade having respective edge regions (31), (41), and (51). FIG. 8B shows an enlargement of the edge regions (31), (41), and (51) before cutting. The front sides (32), (42), and (52) of the edge regions (31), (41), and (51), respectively, are flat. In FIG. 8C the movement of the debris with respect to the front side (32) of the edge region (31), front side (42) of the edge region (41) and front side (52) of the edge region (51), when the corrugated blade cuts a portion of a material, schematically represented by reference numeral (54), is shown by arrows (33), (43), and (53), respectively.

The kind of concavity assumed by the different portions of the blade when the blade is in use depends on the ratio between the outflow of the central material and outflow of the outer edges material of the blade, and on the ratio between outflows of material from different outer edges of the blade, when the blade is in operation. In particular, for the transition portions of the blade the ratio between outflow of the central material and outflow of the outer edge material is a function of the angle of inclination of the transition portion of the blade. For example, for the preferred inclination of the transition portion is 45 degree, results in a symmetrical concave shape of the transition portion (4) when the blade is in use.

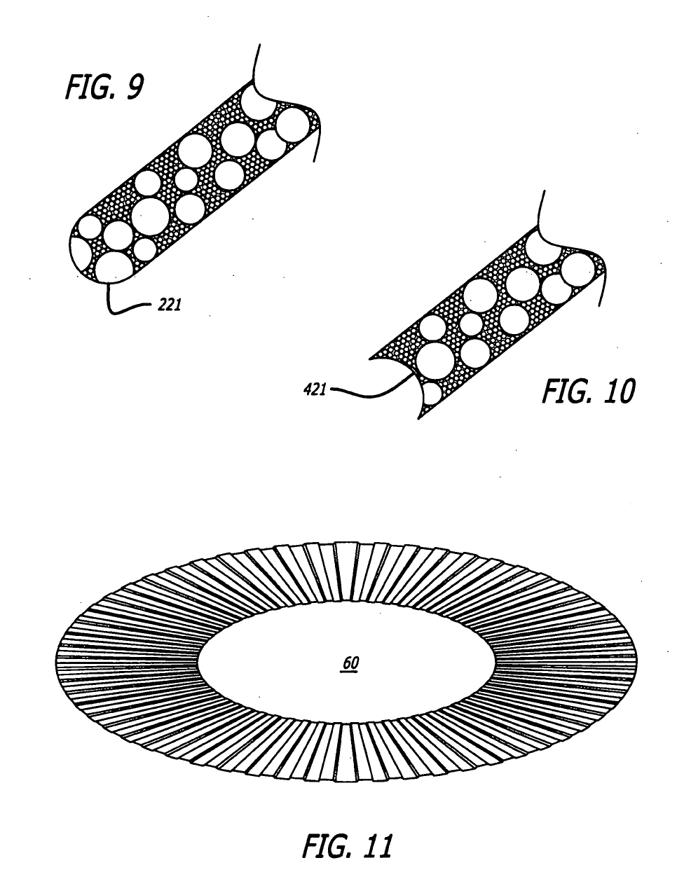

FIG. 8D shows the edge regions (31), (41), and (51) after repeated cutting operations. The front side (32) of the edge region (31) is concave towards the bottom, the front side (42) of the edge region (41) is concave both on the top and the bottom and the front side (52) of the edge region (51) is concave towards the top, as better shown in the cross-sectional view of FIG. 8E. However, the structure shown in the present disclosure, where the combination between the binder material and the abrasive material (in the cases of large particles only, and combined large particles and small particles), is also suitable for cases where the front side of the edge region assumes a convex shape, as shown by comparing FIG. 9 with FIG. 10.

FIG. 9 shows a cross-section similar to the cross-section of FIG. 7E, having a convex front side (221), where there is shown the combined binder material and large particles of abrasive material structure according to one of the embodiments of the present disclosure. The person skilled in the art will appreciate that such structure still maintains a cutting potential due to the presence of the internal large particles of abrasive material.

FIG. 10 shows a cross section similar to the cross-section of FIG. 8E, having a concave front side (421), where there is shown the combined binder material and large particles of abrasive material structure according to the present disclosure. The person skilled in the art will appreciate that the difference in performance between such structure and the structure of FIG. 9 is much less than the difference between the structures of FIG. 8E and the structure of FIG. 7E.

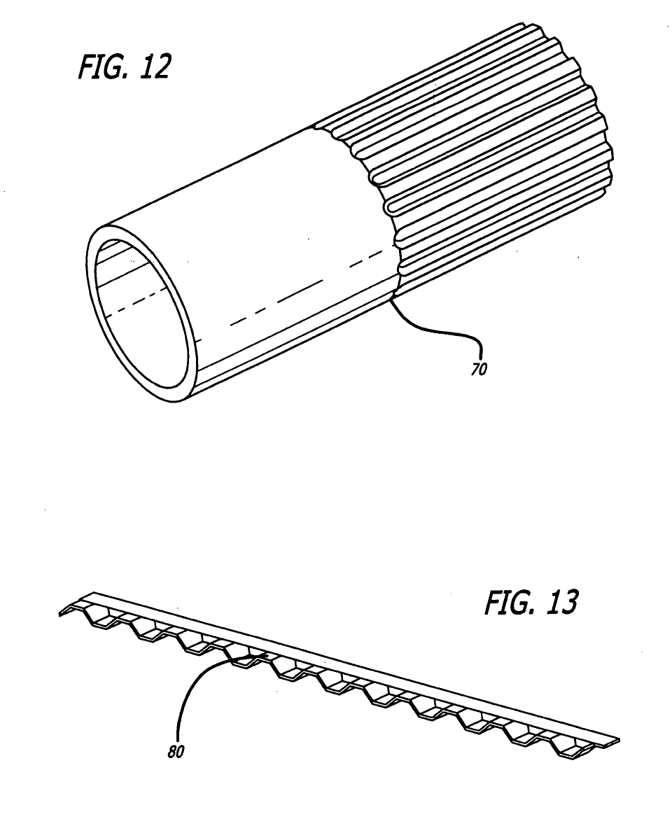

The person skilled in the art will understand that the blade shown herein can be used in many configurations such as a disc or ring (60), as shown in FIG. 11, a pipe (70) as shown in FIG. 12, or a ribbon (80) as shown in FIG. 13. The person skilled in the art will also understand that the blade shown in those configurations is usually operated in presence of a support, a hub, or a mandrel. The particular structure of those elements will not be discussed in detail in the present application, such elements being identifiable by a person skilled in the art upon reading of the present disclosure.

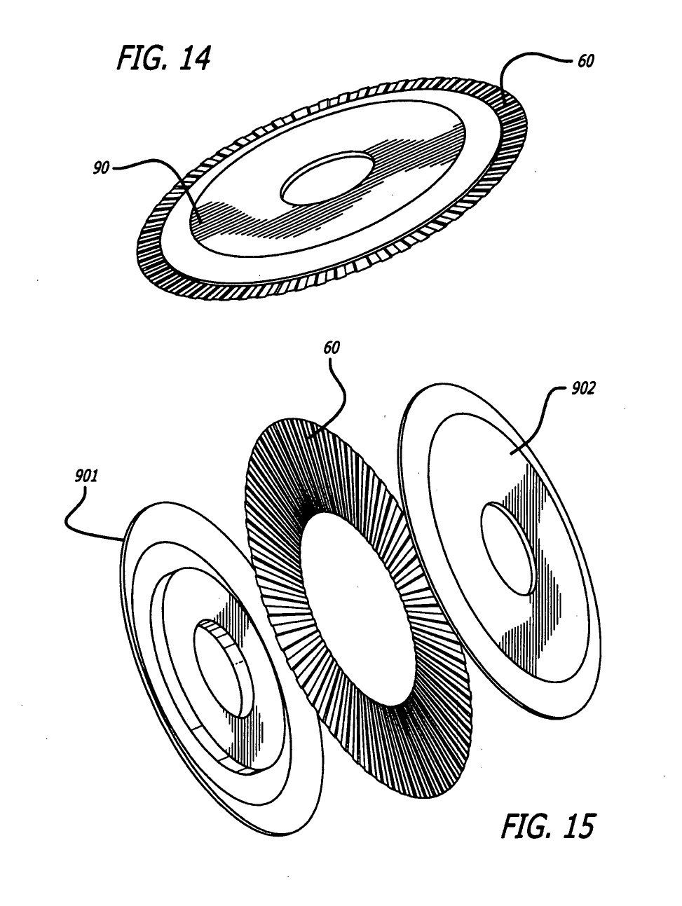

FIGS. 14 and 15 show a disc (60) made in accordance with the present disclosure together with a hub (90). The hub (90) includes a first half (901) and a second half (902). The disc (60) is sandwiched between the first half (901) and the second half (902), which are then secured.

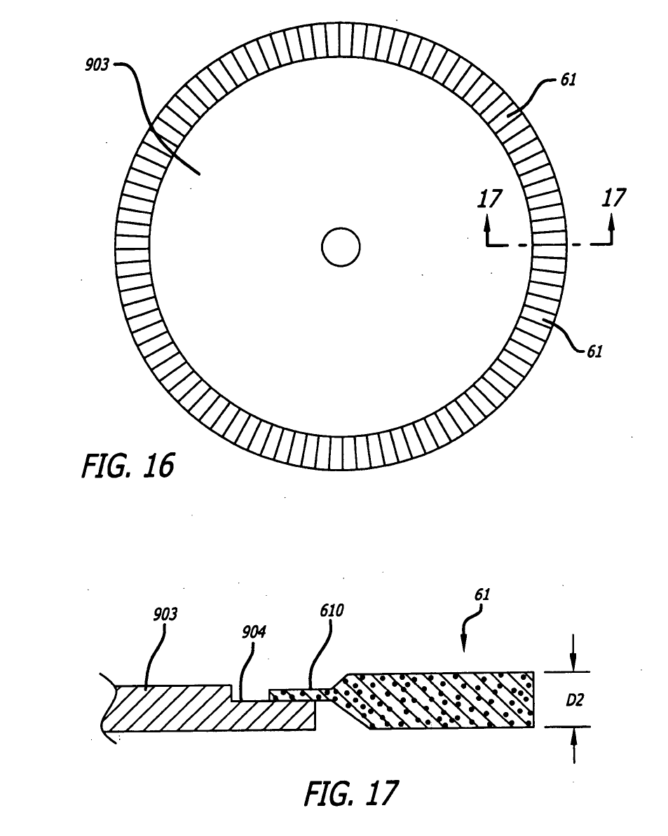

FIG. 16, shows a plan view of a very large circular blade or ring (61) and a thick binder material blank or support (903). FIG. 17 shows an enlarged cross-sectional view of the blade (61) and support (903) along line 17-17 of FIG. 16. The blade (61) has a mounting flange (601). The blade (61) includes large particles (81) encapsulated in binder material (9) with small particles (not shown) and corresponds to blade shown in FIG. 6.

In the embodiment of FIGS. 16 and 17, the blade (61) can easily be fabricated in diameters of four or more feet.

The disc shaped support (903) is provided with a step-down annular ring-shaped shoulder or shelf (904), which is deeper than the thickness of the mounting flange (610), formed integrally with the annular corrugated singulation blade (61). In the embodiment shown in FIG. 17, the depth D2 of the blade (61) provides a clearance in the cut of on each side of the support (903). The flange (601) may be attached to shelf (904) by numerous known welding techniques including spot or seam welding or by brazing or rod welding including tungsten inert gas (TIG) welding or glued using proper adhesives. Corrugated rings (61) may be made in existing metal baths up to twenty feet in diameter.

Other kind of hubs identifiable by the person skilled in the art can be suitably used with the blade of the disclosure. Also other possible arrangements of the disc blade and the hub are identifiable by the person skilled in the art upon reading of the present disclosure.

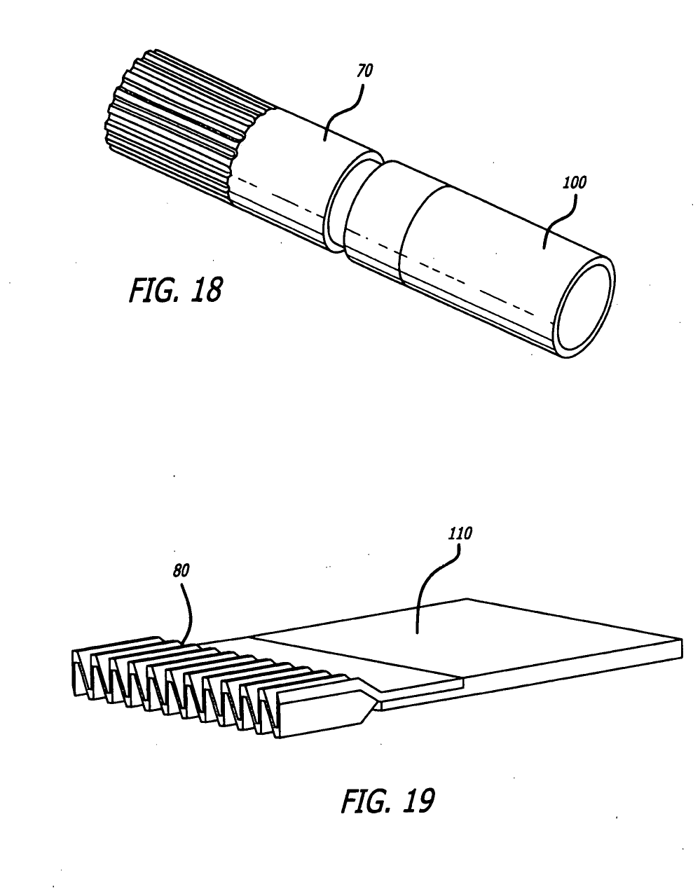

FIG. 18 shows a pipe (70) with a support (100). An embodiment of the saw blade according to the present disclosure is positioned at the left end of the pipe (70), along the circular periphery of such left end. Preferably, the internal diameter of the pipe is larger than the inner diameter of the cylinder containing the saw blade, and the external diameter of the pipe is smaller than the outer diameter of such cylinder, in order for the core not to bind into the pipe.

If the drill pipe is employed to cut through objects thinner than the length of the cylinder, the pipe or drill stem may be solid.

FIG. 19 shows a ribbon-like structure (80) similar to the structure shown in FIG. 13, together with a support (110) similar to the support (903) shown in FIG. 17. FIG. 19 shows a preferred embodiment wherein the distance between the leftmost edge of the support (110) and the blade (80) is reduced to virtually zero.

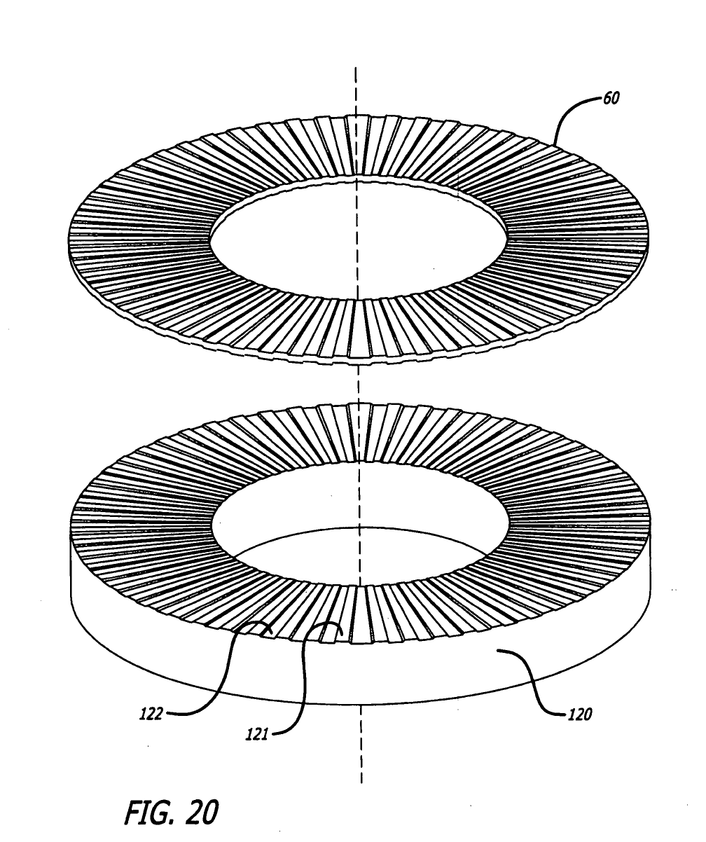

FIG. 20 shows a perspective view of an electroforming mandrel (120) used to manufacture corrugated blades according to the present disclosure, for example configured such as a disc (60). The mandrel (120) has raised surfaces (121) and lowered surfaces (122). Such mandrel may be machined from stainless steel or formed from a moldable material and plated with a surface equivalent to stainless steel, which does not require a release agent such as electro-conductive carbon, as know by the person skilled in the art.

When a large disc-shaped corrugated blade has to be made, the blade (60) may be deposited directly on the support mandrel (120) or made separately and attached as explained hereinafter. In particular, a blade can be manufactured as explained hereinafter and then clamped, welded, glued or attached to the support by other means identifiable by a person skilled in the art upon reading of the present disclosure.

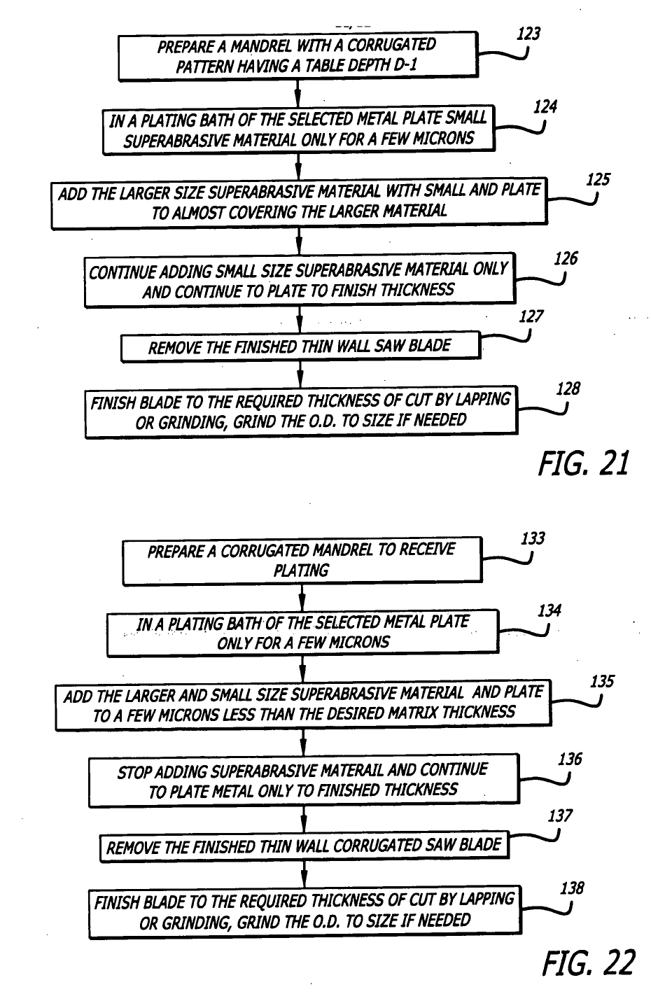

FIG. 21 shows a block diagram of the method step or operations (123) to (128) for manufacture a corrugated blade (1) in the embodiment shown in FIG. 6.

In a first step (123), a mandrel having a corrugated pattern (see FIG. 20) is provided.

In a second step (124), the small abrasive material particles are plated in a metal plating bath (for example a nickel plating bath).

In a third step (125), the larger abrasive material particles are added.

In a fourth step (126), additional small particles of abrasive material are added, and plating is performed up to a desired thickness.

In a fifth step (127) the blade is removed, and further finished in a sixth step (128).

A blade, such as the one in FIG. 6, in the case where the external periphery of the blade (1) is formed by binder material (91) and small particles (11) only, can be obtained by this method. The amount dimensions and nature of large particles and small particles of abrasive material as well as amount of binder material, temperatures timing and other conditions of the process depend on the desired characteristics of the blade and are identifiable by a person skilled in the art upon reading of the present disclosure in view of the desired blade to be manufactured.

FIG. 22 shows a further embodiment of a method according to the present disclosure.

In a first step (133), a mandrel having a corrugated pattern is provided.

In a second step (134), a metal plating bath is performed.

In a third step (135), both the larger and small size abrasive material particles are added and plating is performed to a few microns less than the desired matrix thickness.

In a fourth step (136), addition of abrasive material is stopped and only the binder material is plated, up to the desired thickness.

The fifth and sixth steps (137) and (138) are equivalent to steps (127) and (128) already discussed above.

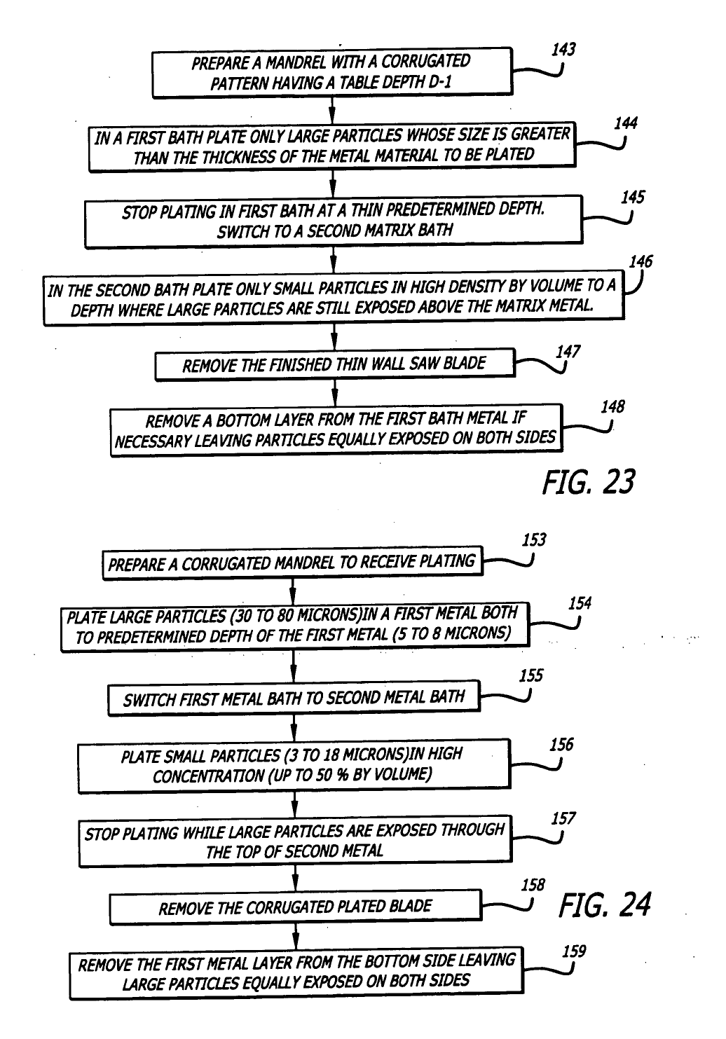

FIG. 23 shows a method for manufacturing a blade according to a third embodiment of the present disclosure.

In a first step (143), a mandrel having a corrugated pattern is provided.

Differently from the two previous embodiments, two plating baths are provided. According to a second step (144), in a first bath plate, for example a copper bath, only those large abrasive particles whose size, are plated.

In a third step (145), after a certain amount of time, plating in the first bath is stopped at a thin predetermined depth. The large particles will be plated in amounts and for a time such that the plated particles will be slightly buried in the binder material of the first bath and exposed above it.

In a fourth step (146), a second bath plate is performed, for example a nickel bath, where only small abrasive particles are plated in high density by volume, to a depth where the large abrasive particles are still exposed above the matrix binder material preferably by on average the same amount as the depth of the first plating bath.

In a fifth step (147) the finished saw blade is removed and, in a sixth step (148), a bottom layer is removed from the first bath metal if necessary, leaving the particles equally exposed on both sides.

It is possible to perform the plating steps in a single plating tank when the disc is small. To do this, the tank used for plating is flushed when switching to a different plating bath. Usually, it is easier to switch the mandrel to different plating baths and baths with different size particles, as shown with reference to the method described in FIG. 23.

FIG. 24, shows a fourth embodiment of a method according to the disclosure, where two binder material materials are used.

In a first step (153), a corrugated mandrel is prepared to receive plating.

In a second step (154) the large abrasive particles (30 to 80 microns large, for example) are plated in a first metal bath, such as a copper bath, to a predetermined depth of the first metal bath (5 to 8 microns, for example) to provide a partying layer.

In a third step (155-156), the small particles are plated in a second metal bath, such as a nickel bath.

In a fourth step (157) plating is stopped while the large abrasive particles are still exposed through the top of the second metal.

In a fifth step (158) the corrugated plated blade is removed.

In a sixth step (159), the first metal layer is removed from the bottom side leaving the large abrasive particles equally exposed on both sides.

Preferably, a partying layer can be provided for steps (154) and (155), resulting in the elimination of step (159). The method of FIG. 22 can be employed to manufacture thin wall singulation saw blade that may be used or attached to support disc or bands saw blades. When steps (154) and (155) are omitted, the large abrasive particles are preferably plated on a special mandrel that allows the large abrasive particles to protrude from the bottom wall or boss. The small abrasive particles may be plated on the same bath on which the large abrasive particles were plated.

The embodiments of FIGS. 21 to 24 can also be used to manufacture blades including large particles only, as shown in FIGS. 3 and 4.

The particular combination between binder material and abrasive material is selected in accordance with the type of material to be cut. In the preferred embodiment, diamond and nickel are used. Some substrates require a friable abrasive material that always maintains a sharp edge by fracturing to obtain the proper finish, such as Cubic Boron Nitride. Some other substrates require a softer or harder matrix binder material to obtain the proper finish.

1. An abrasive blade for cutting material, the blade comprising:
(a) a plurality of raised portions;
(b) a plurality of recessed portions; and
(c) a plurality of transition portions, each transition portion connecting a raised portion with a recessed portion;
(d) each of the plurality of raised portions being substantially flat;
(e) each of the plurality of recessed portions being substantially flat and spaced laterally from the plurality of raised portions;
(f) the plurality of raised portions, the plurality of recessed portions, and the plurality of transition portions forming corrugations in the abrasive blade.

2. An abrasive blade as claimed in claim 1, wherein each transition portion is angled relative to the raised portion and the recessed portion by an angle in the range 30 to 90 degrees.

3. An abrasive blade as claimed in claim 2, wherein the angle is 45 degrees.

4. An abrasive blade as claimed in claim 2, wherein each of the recessed portions is spaced longitudinally of the raised portions and are parallel to the raised portions.

5. An abrasive blade as claimed in claim 1, wherein the raised portion and the recessed portion each have a front edge that forms a corrugated edge at the junction with the transition portion.

6. An abrasive blade as claimed in claim 1, wherein each raised portion and each recessed portion has a top portion surface and a bottom portion surface, a distance between the top portion surface of a raised portion and the bottom portion surface of a recessed portion defining a curf width of the blade, a distance between the top portion surface and the bottom portion surface defining a portion depth of the blade, a ratio between the portion depth and the curf width of the blade defining a corrugation depth of the blade, the corrugation depth being less than 1.

7. The abrasive blade of claim 6, wherein the blade comprises a mixture of a binder material and particles of abrasive material encapsulated in the binder material.

8. The abrasive blade of claim 7, wherein the particles comprise large particles having a dimension no greater than 50% of the depth portion, and small particles having a dimension in a range of 10% to 30% of the dimension of the large particles.

9. The abrasive blade of claim 7, wherein the blade has a top blade surface and a bottom blade surface, a distance between the top blade surface and the bottom blade surface defining a blade depth, and the particles of abrasive material include large particles of abrasive material, each large particle having a dimension in a range of 10% to 50% the blade depth.

10. The abrasive blade of claim 9, wherein the large particles of abrasive material are in an amount of about 30% to about 40% by volume.

11. An abrasive blade for cutting material, the abrasive blade comprising:
(a) a plurality of raised portions, recessed portions and transition portions, each transition portion connecting a raised portion with a recessed portion;
(b) each portion having a top portion surface and a bottom portion surface;
(c) a distance between the top portion surface of a raised portion and the bottom portion surface of a recessed portion defining a curf width of the blade;
(d) a distance between the top portion surface and the bottom portion surface defining a portion depth of the blade; and
(e) a ratio between the portion depth and the curf width of the blade defining a corrugation depth of the blade, the corrugation depth being less than 1.

12. The abrasive blade of claim 11, wherein each transition portion has an inclination relative to the raised portion and recessed portion connected by said each transition portion, the inclination being less than 90 degrees.

13. The abrasive blade of claim 12, wherein each transition portion has an inclination relative to the raised portion and recessed portion connected by said each transition portion, the inclination being 45°±15°.

14. The abrasive blade of claim 11, wherein the corrugation depth is substantially uniform along the blade.

15. The abrasive blade of claim 11, wherein the blade has a contacting surface adapted to contact the material during cutting, and comprises a mixture of binder material and particles of abrasive material encapsulated in the binder material, the particles forming at least a portion of the contacting surface of the blade.

16. The abrasive blade of claim 15, wherein the particles comprise large particles having a dimension ≦50% of the depth portion, and small particles having a dimension in a range of 10% to 30% of the dimension of the large particles.

17. An abrasive blade for cutting materials, the blade made of a mixture of binder material, large particles of abrasive material and small particles of abrasive material, the large and small particles of abrasive material being encapsulated in the blade, the blade having a contacting surface adapted to contact the materials during cutting, wherein the small particles of abrasive material at least in part protect the binder material during cutting.

18. The abrasive blade of claim 17, wherein the blade has a top blade surface and a bottom blade surface, a distance between the top blade surface and the bottom blade surface defining a blade depth, and the large particles of abrasive material each has a dimension in a range of 10% to 50% the blade depth.

19. The abrasive blade of claim 18, wherein the large particles of abrasive material are in an amount of about 30% to about 40% by volume of the abrasive blade.

20. The abrasive blade of claim 17, wherein the blade is a corrugated blade having an upper surface and a lower surface, including raised portions, recessed portions and transition portions, the transition portions connecting the raised portions and the recessed portions.

21. The abrasive blade of claim 20, wherein each portion has a top portion surface and a bottom portion surface, the large and small particles of abrasive material encapsulated in the binder material being distributed between the top portion surface and the bottom portion surface.

22. The abrasive blade of claim 21, wherein a distance between the top portion surface and the bottom portion surface defines a portion depth of the blade, the portion depth being about 10% to 60% of a distance between the top portion surface of a raised portion and the bottom portion surface of a recessed portion of the blade.

23. The abrasive blade of claim 20, wherein each transition portion has an inclination relative to the raised portion and recessed portion connected by said each transition portion, the inclination being 45°±15°.

24. An abrasive blade for cutting materials, the blade having an upper surface, a lower surface, and a blade depth defined by a distance between the upper surface and the lower surface, the blade comprising:
(a) a mixture of binder material and particles of abrasive material;
(b) the particles comprising large particles and small particles;
(c) the large particles having a large particle dimension up to about 50% the blade depth; and
(d) the small particles having a small particle dimension from about 10% to about 30% the large particle dimension.

25. The abrasive blade of claim 24, wherein the blade has a contacting surface adapted to contact the materials during cutting and a portion of the contacting surface is formed by the particles of abrasive material.

26. The abrasive blade of claim 24, wherein the large particles are encapsulated in the binder material and are in an amount of about 30% to about 40% by volume of the abrasive blade; and the small particles are encapsulated in the binder material and are in an amount of about 10% to about 20% by volume of the abrasive blade.

27. The abrasive blade of claim 24, wherein the blade is a corrugated blade, including raised portions, recessed portions and transition portions, the transition portions connecting the raised portions and the recessed portions.

28. The abrasive blade of claim 24, wherein the blade is a singulation saw blade; the binder material being a metal and the abrasive material being diamond.

29. The abrasive blade of claim 24, wherein the blade has a shape selected from the group consisting of a disc shape, a pipe shape, and a ribbon shape.

30. An abrasive blade for cutting material, the blade comprising a plurality of raised portions, recessed portions and transition portions, each transition portion connecting a raised portion with a recessed portion, each portion having a top portion surface and a bottom portion surface, a distance between the top portion surface of a raised portion and the bottom portion surface of a recessed portion defining a curf width of the blade, a distance between the top portion surface and the bottom portion surface defining a portion depth of the blade, and a ratio between the portion depth and the curf width of the blade defining a corrugation depth of the blade, the corrugation depth being less than 1, the abrasive blade comprising:
(a) a mixture of binder material and particles of abrasive material encapsulated in the binder material; and
(b) the particles of abrasive material including large particles having a diameter ≦50% the depth of the blade and small particles having a diameter in a range from 10% to 30% of the diameter of the large particles.

31. The abrasive blade of claim 30, wherein the blade has a contacting surface adapted to contact the material during cutting, wherein a portion of the contacting surface is formed by the large particles of abrasive material.

32. The abrasive blade of claim 30, wherein the transition portions have an inclination angle in a range of 30° to 600° with respect to the raised portions and recessed portions.

33. The abrasive blade of claim 32, wherein the blade is a singulation saw blade.

34. The abrasive blade of claim 30, wherein the blade has a shape selected from the group consisting of a disc shape, a pipe shape, and a ribbon shape.

35. A method for manufacturing an abrasive blade having a blade depth, the method comprising:
(a) mixing together a binder material and abrasive particles, the abrasive particles comprising large abrasive particles and small abrasive particles, the large abrasive particles having a dimension of ≦50% of the blade depth, the small particles having a dimension in a range of 10% to 30% the dimension of the large particles; and
(b) plating the mixed binder material and abrasive particles.

36. The method of claim 35, wherein plating is performed on a mandrel.

37. The method of claim 35, further comprising removing the plated mixed binder material and abrasive material from the mandrel.

38. A method for manufacturing an abrasive blade comprising:
(a) plating first abrasive material particles in a binder material plating bath;
(b) adding second abrasive material particles having a dimension greater than the first abrasive material particles to the binder material plating bath;
(c) adding further first abrasive particles; and
(d) performing further plating up to a desired thickness, thus forming a blade where the first abrasive material particles and the second abrasive material particles are encapsulated in the binder material.

39. The method of claim 38, wherein the binder material plating bath is a nickel plating bath.

40. A method for manufacturing an abrasive blade, the method comprising:
(a) providing a mandrel;
(b) performing a binder material plating in a plating bath;
(c) adding large abrasive material particles and small abrasive material particles up to a thickness less than a desired final thickness;
(d) plating the binder material to the desired final thickness without adding large abrasive material particles and small abrasive material thus forming a blade where the large and small particles of abrasive material are encapsulated in the binder material; and
(e) removing the formed blade.

41. The method of claim 40, wherein the mandrel has a corrugated pattern.

42. A method for manufacturing an abrasive blade, the method comprising:
(a) providing a support;
(b) performing a first binder material bath plating where large abrasive material particles are plated on to the support;
(c) stopping the first bath plating at a first predetermined depth; and
(d) performing a second binder material bath plating where small abrasive material particles are plated to a depth less than the depth of the large particles.

43. The method of claim 42, wherein the support is a mandrel having a corrugated pattern.

44. A thin wall singulation blade for cutting materials comprising: a plated binder material matrix for encapsulating large abrasive material and small abrasive material in the binder material matrix, the binder material matrix comprising small abrasive material particles substantially surrounding large abrasive material particles in the binder material matrix; the thin wall singulation blade being corrugated in shape and having a plurality of substantially flat raised portions, and a plurality of substantially flat recessed portions, the raised portions and recessed portions being separated and joined by transition portions.

45. A thin wall singulation blade as claimed in claim 44, wherein the thin wall singulation blade has a depth of corrugation in the range 2 to 10 times the thickness of the thin walls of the thin wall singulation blade.

46. A thin wall singulation saw blade as claimed in claim 44, wherein the matrix material in the thin walls has a cutting area that exceeds the cutting area of the transition portions so that the side walls wear slower than the area between the side walls.

47. A thin wall singulation saw blade as claimed in claim 46, wherein the saw blade has a cutting edge that becomes concave and the center of the blade becomes recessed between two parallel cutting sidewall blades.
